(19) United States
(12) Patent Application Publication
(10) Pub. No.: US 2026/0228611 A1
(43) Pub. Date: Aug. 6, 2026

(54) SYSTEM AND METHOD FOR BUILDING ARTIFICIAL INTELLIGENCE MODELS OR AGENTS WITH IMMUNITY

(71) Applicant: Southern Methodist University, Dallas, TX (US)

(72) Inventors: Xihao Xie, Plano, TX (US); Jia Zhang, Plano, TX (US); Tsengdar J. Lee, Burke, VA (US)

(21) Appl. No.: 19/045,778

(22) Filed: Feb. 5, 2025

(51) Int. Cl. G06N 20/00

(52) U.S. Cl. CPC G06N 20/00

(57) ABSTRACT

A system and computer-implemented method for building an artificial intelligence model or agent with immunity includes providing a trusted dataset, a baseline model and a judge model, training a dynamic model from a new dataset, updating the new dataset with estimations from the judge model, refreshing the baseline model with the trained dynamic model, and augmenting the trusted dataset with the updated new dataset.

### STATEMENT OF FEDERALLY FUNDED RESEARCH

This invention was made with government support under 80NSSC22K0144 awarded by the National Aeronautics and Space Administration. The government has certain rights in the invention.

### CROSS-REFERENCE TO RELATED APPLICATIONS

Not applicable.

### TECHNICAL FIELD OF THE INVENTION

The present disclosure relates in general to artificial intelligence, and more particularly, to systems and methods for building artificial intelligence models or agents with immunity.

### BACKGROUND OF THE INVENTION

Without limiting the scope of the disclosure, its background is described in connection with machine learning-based data-driven artificial intelligence technologies.

In recent years, machine learning-based data-driven artificial intelligence technologies have advanced at a remarkable rapid pace. Modern machine learning-based AI agents acquire/learn knowledge by identifying patterns and regularities within datasets. This approach has enabled AI systems to achieve unprecedented success across fields like image classification, speech recognition, text generation, and automation control. However, this learning approach, with its inherent tendency to indiscriminately absorb and fit to data, has also introduced a range of issues and challenges. One critical challenge is the immunity of the AI models to undesirable data (e.g., misinformation, disinformation, biased data, erroneous data, etc.) trained through this approach. On the one hand, with the explosive rise of generative AI systems like ChatGPT and DALL-E 3, vast volumes of data are now generated or synthesized. Over time, models trained on such generated or synthetic data are likely to experience issues such as degradation or even collapse. On the other hand, the core assumption of this learning approach—that data is inherently reliable—often falls short in real-world applications. If data is tampered with, biased, fake, or misleading, the AI systems trained on it become unreliable. Accordingly, to ensure that machine learning-based AI systems can not only adapt to new data from new environments but also maintain a level of discernment for data quality, a new machine learning paradigm is becoming increasingly desirable. This paradigm would enhance the reliability and immunity of AI models trained under such conditions.

### SUMMARY OF THE INVENTION

Methods and systems for designing and developing artificial intelligence models with immunity to undesirable data (e.g., misinformation, disinformation, biased data, erroneous data, etc.) are disclosed herein. The system is a computer-based software application, capable of training an artificial intelligence model/agent that replicates how humans learn from the external world with immunity to undesirable data-such that it can discern valuable information and develop resilience against misinformation, disinformation, biased data, erroneous data, etc. A baseline model and a judge model are first trained with golden authoritative data. For newly arrived data, a dynamic model is trained.

As embodied and broadly described herein, a computer-implemented method for building an artificial intelligence model or agent with immunity includes providing a trusted dataset, training a baseline model and a judge model, training a dynamic model from a new dataset, updating the new dataset with estimations from the judge model, refreshing the baseline model with the trained dynamic model, and augmenting the trusted dataset with the updated new dataset.

In one aspect, the training, updating, refreshing, and augmenting steps are repeated continuously, periodically, upon request, or upon receiving additional new datasets. In another aspect, the method further includes receiving one or more queries or tasks, and responding to the one or more queries or tasks using the augmented trusted dataset. In another aspect, providing the trusted dataset includes building the trusted dataset, by a processing device or a system or a computerized tool, from an initial dataset; providing the baseline model includes training the baseline model from the trusted dataset; and providing the judge model includes training the judge model from the trusted dataset. In another aspect, building the trusted dataset further includes determining whether a mapping from a feature representation to a label is credible or not, and determining a credibility score of the mapping for each data point in the initial dataset. In another aspect, determining the credibility score of the mapping for each data point in the initial dataset is conducted by humans, experts, or computerized systems based on authoritative evaluations. In another aspect, the credibility score of the mapping for each data point in the initial dataset is determined by an evaluation algorithm. In another aspect, training the baseline model from the trusted dataset further includes fetching feature representations and labels for all data points in the trusted dataset, and training the baseline model by updating one or more baseline model parameters via stochastic gradient descent (SGD). In another aspect, fetching the feature representations includes fetching digitalized representations or vectorized real-valued embeddings. In another aspect, training the judge model from the trusted dataset further includes fetching feature representations, labels and credibility scores for all data points in the trusted dataset, and training the judge model by updating one or more parameters of the judge model via stochastic gradient descent (SGD). In another aspect, fetching the feature representations include fetching digitalized representations or vectorized real-valued embeddings. In another aspect, training the dynamic model includes fetching feature representations and labels for all data points from the new dataset, specifying an aligned label for each data point in the new dataset, and updating one or more dynamic model parameters via stochastic gradient descent (SGD). In another aspect, fetching the feature representations includes fetching digitalized representations or vectorized real-valued embeddings. In another aspect, specifying the aligned label for each data point in the new dataset includes estimating a predicted value for the feature representation of each data point in the new dataset, estimating a maximum transformation probability of the feature representation of each data point in the new dataset to the feature representations over all existing data points in the trusted dataset, and locating the data point in the trusted dataset which holds the maximum transformation probability. In another aspect, estimating the predicted value for the feature representation of each data point in the new dataset is obtained from an output from the baseline model by taking the feature representation of the data point in the new dataset as an input. In another aspect, estimating the maximum transformation probability of the feature representation of each data point in the new dataset to the feature representations over all existing data points in the trusted dataset is based on a similarity between the feature representation of each data point in the new dataset and the feature representation over all existing data points in the trusted dataset. In another aspect, updating the new dataset with estimations from the judge model includes estimating a credibility score for each data point in the new dataset, augmenting each data point with the estimated credibility score. In another aspect, estimating the credibility score for each data point in the new dataset is obtained from an output from the judge model by taking the feature representation and the estimated label of the data point in the new dataset as an input. In another aspect, refreshing the baseline model with the trained dynamic model refreshes one or more baseline model parameters with one or more dynamic model parameters. In another aspect, augmenting the trusted dataset with the updated new dataset appends the updated new dataset to the trusted dataset.

As embodied and broadly described herein, a computerized system for building an artificial intelligence model or agent with immunity includes a trusted dataset, a baseline model, a judge model, a dynamic model, and one or more processors communicably coupled to the trusted dataset, the baseline model, the judge model and the dynamic model. The one or more processors train the dynamic model from a new dataset, update the new dataset with estimations from the judge model, refresh the baseline model with the trained dynamic model, and augment the trusted dataset with the updated new dataset.

In one aspect, the one or more processors repeat the training, updating, refreshing, and augmenting steps continuously, periodically, upon request, or upon receiving additional new datasets. In another aspect, the one or more processors further receive one or more queries or tasks, and respond to the one or more queries or tasks using the augmented trusted dataset. In another aspect, the one or more processors further build the trusted dataset from an initial dataset, train the baseline model from the trusted dataset, and train the judge model from the trusted dataset. In another aspect, the one or more processors build the trusted dataset by determining whether a mapping from a feature representation to a label is credible or not, and determining a credibility score of the mapping for each data point in the initial dataset. In another aspect, the one or more processors determine the credibility score of the mapping for each data point in the initial dataset from input received from humans, experts, or computerized systems based on authoritative evaluations. In another aspect, the credibility score of the mapping for each data point in the initial dataset is determined by an evaluation algorithm. In another aspect, the one or more processors train the baseline model from the trusted dataset by fetching feature representations and labels for all data points in the trusted dataset, and training the baseline model by updating one or more baseline model parameters via stochastic gradient descent (SGD). In another aspect, fetching the feature representations includes fetching digitalized representations or vectorized real-valued embeddings. In another aspect, the one or more processors train the judge model from the trusted dataset by fetching feature representations, labels and credibility scores for all data points in the trusted dataset, and training the judge model by updating one or more judge model parameters via stochastic gradient descent (SGD). In another aspect, fetching the feature representations include fetching digitalized representations or vectorized real-valued embeddings. In another aspect, the one or more processors train the dynamic model by fetching feature representations and labels for all data points from the new dataset, specifying an aligned label for each data point in the new dataset, and updating one or more dynamic model parameters via stochastic gradient descent (SGD). In another aspect, fetching the feature representations includes fetching digitalized representations or vectorized real-valued embeddings. In another aspect, specifying the aligned label for each data point in the new dataset includes estimating a predicted value for the feature representation of each data point in the new dataset, estimating a maximum transformation probability of the feature representation of each data point in the new dataset to the feature representations over all existing data points in the trusted dataset, and locating the data point in the trusted dataset which holds the maximum transformation probability. In another aspect, estimating the predicted value for the feature representation of each data point in the new dataset is obtained from an output from the baseline model by taking the feature representation of the data point in the new dataset as an input. In another aspect, estimating the maximum transformation probability of the feature representation of each data point in the new dataset to the feature representations over all existing data points in the trusted dataset is based on a similarity between the feature representation of each data point in the new dataset and the feature representation over all existing data points in the trusted dataset. In another aspect, the one or more processors update the new dataset with estimations from the judge model by estimating a credibility score for each data point in the new dataset, and augmenting each data point with the estimated credibility score. In another aspect, estimating the credibility score for each data point in the new dataset is obtained from an output from the judge model by taking the feature representation and the estimated label of the data point in the new dataset as an input. In another aspect, the one or more processors refresh the baseline model with the trained dynamic model by refreshing one or more baseline model parameters with one or more dynamic model parameters. In another aspect, the one or more processors augment the trusted dataset with the updated new dataset by appending the updated new dataset to the trusted dataset.

As embodied and broadly described herein, the baseline, judge, and dynamic models can be each implemented as a common-sense machine learning model. Their individual learning rates can be independently scheduled (configured and dynamically adjusted) throughout their training process to improve convergence.

As embodied and broadly described herein, the foregoing method and system can be implemented as one or more non-transitory computer-readable media that stores instructions that when executed cause a computing device or system to perform the stated operations.

### BRIEF DESCRIPTION OF THE DRAWINGS

For a more complete understanding of the features and advantages of the present invention, reference is now made to the detailed description of the disclosure along with the accompanying figures, in which:

FIG. 1 shows a flow diagram of a method for building artificial intelligence (AI) models or agents with immunity to undesirable data according to an implementation of the disclosure.

FIG. 2 shows a simple diagram of a high-level flow for building artificial intelligence (AI) models or agents with immunity according to an implementation of the disclosure.

FIG. 3 shows three components of a data point in the trusted or golden dataset according to an implementation of the disclosure.

FIGS. 4-6 show exemplary data points in the trusted or golden dataset for three different learning problems of supervised classification, supervised regression, and reinforcement learning, respectively, according to an implementation of the disclosure.

FIG. 7 shows two components, feature representation and label, of a data point in the initial dataset and the newly arrived dataset according to an implementation of the disclosure.

FIGS. 8-10 show exemplary data points in the initial dataset and the newly arrived dataset for three different learning problems of supervised classification, supervised regression, and reinforcement learning, respectively, according to an implementation of the disclosure.

FIG. 11 shows a flow diagram of a method for building artificial intelligence (AI) models or agents according to an implementation of the disclosure.

### DETAILED DESCRIPTION OF THE INVENTION

Illustrative embodiments of the system of the present application are described below.

In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

Methods and systems for designing and developing artificial intelligence models with immunity to undesirable data (e.g., misinformation, disinformation, biased data, erroneous data, etc.) are disclosed herein. The system is a computer-based software application, capable of training an artificial intelligence model/agent with immunity that replicates how humans learn from the external world with immunity-such that it can discern valuable information and develop resilience against misinformation, disinformation and bias. A baseline model and a judge model are first trained with golden authoritative data. For newly arrived data, another dynamic model is trained secondly with immunity.

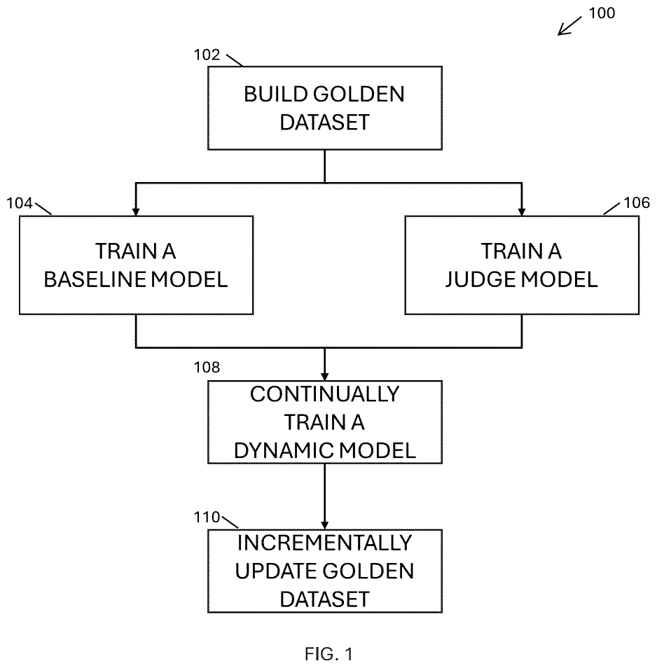

Now referring to FIG. 1, a flow diagram of a method 100 for building artificial intelligence (AI) models or agents with immunity according to an implementation of the disclosure is shown. A trusted or golden dataset is built in block 102. The golden dataset, also referred to as a fundamental dataset, contains a curated collection of high-quality data typically from a trusted source. The trusted or golden dataset preferably contains data that is accurate, consistent, complete, timely and bias-free. The trusted or golden data set is used to train a baseline model in block 104 and a judge model in block 106. Thereafter, a dynamic model is trained from a new data set in block 108. Combining them in the whole system is to trade-off between trusted or golden data and newly arrived data so that the system can be not only coherent to a golden standard but also adaptive to new environment. The judge model is used to grade the accuracy or credibility of new datasets based on the trusted or golden dataset. The trusted or golden dataset is incrementally updated based on new datasets that have been updated based on the judge model in block 110. Additional details and implementations will be described below.

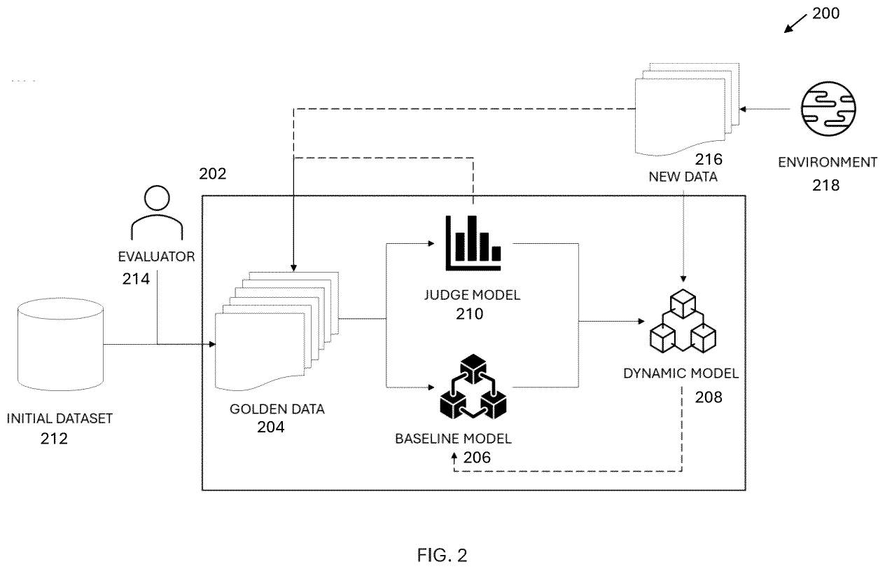

Referring now to FIG. 2, a simple diagram of a high-level flow 200 for building artificial intelligence (AI) models or agents with immunity according to an implementation of the disclosure is shown. A computerized system or platform 202 for building an artificial intelligence model or agent with immunity includes a trusted or golden dataset 204, a baseline model 206, a dynamic model 208 and a judge model 210. The trusted or golden dataset 204, the baseline model 206, the dynamic model 208 and the judge model 210 can all be stored within one or more memories or storage devices, which can local, remote or distributed. One or more processors, computing devices or computing systems are communicably coupled to the trusted or golden dataset 204, the baseline model 206, the dynamic model 208 and the judge model 210.

The trusted or golden dataset 204 is built from an initial dataset 212 by determining whether a mapping from a feature representation to a label is credible or not, and determining a credibility score of the mapping for each data point in the initial dataset 212. The credibility score of the mapping for each data point in the initial dataset 212 is received from an evaluator 214, which can be humans, experts, computerized systems based on authoritative evaluations (e.g., evaluation algorithms, etc.), or a combination thereof. The baseline model 206 is trained from the trusted or golden dataset 214 by fetching feature representations and labels for all data points in the trusted or golden dataset 204 and updating one or more baseline model parameters via stochastic gradient descent (SGD). Fetching the feature representations may include fetching digitalized representations or vectorized real-valued embeddings. The judge model 210 is trained from the trusted or golden dataset 214 by fetching feature representations, labels and credibility scores for all data points in the trusted dataset and updating one or more judge model parameters via stochastic gradient descent (SGD).

The dynamic model 208 is trained by fetching feature representations and labels for all data points from a new dataset 216, specifying an aligned label for each data point in the new dataset 216, and updating one or more dynamic model parameters via stochastic gradient descent (SGD). The new dataset 216 can be received or generated from inside the system 202 or outside the system 202, such as environment 218. Specifying the aligned label for each data point in the new dataset 216 includes estimating a predicted value for the feature representation of each data point in the new dataset 216, estimating a maximum transformation probability of the feature representation of each data point in the new dataset 216 to the feature representations over all existing data points in the trusted or golden dataset 204, and locating the data point in the trusted or golden dataset 204 which holds the maximum transformation probability. Estimating the predicted value for the feature representation of each data point in the new dataset 216 is obtained from an output from the baseline model 206 by taking the feature representation of the data point in the new dataset 216 as an input. Estimating the maximum transformation probability of the feature representation of each data point in the new dataset 216 to the feature representations over all existing data points in the trusted or golden dataset 204 is based on a similarity between the feature representation of each data point in the new dataset 216 and the feature representation over all existing data points in the trusted or golden dataset 204.

The dynamic model 210 updates the new dataset 216 with estimations. More specifically, each data point in the new dataset 216 is augmented with an estimated credibility score for that data point. The estimated credibility score for each data point in the new dataset 216 can be obtained from the judge model 210 by inputting the feature representation and the corresponding label of the data point in the new dataset 218. Thereafter, the baseline model 206 is refreshed with the dynamic model 208. More specifically, one or more baseline model parameters are refreshed with one or more dynamic model parameters. The trusted or golden dataset 204 is updated by appending the updated new dataset to the trusted or golden dataset 204, which can be saved to a memory or storage device. This training process can be repeated continuously, periodically, upon request, or upon receiving additional new datasets. Moreover, the system or platform 202 may receive one or more queries or tasks and respond to the one or more queries or tasks using the augmented trusted or golden dataset.

The training parameters for the baseline model, the judge model, and the dynamic model will now be described in more detail. Given a trusted or golden dataset [symbol] ={ [symbol] x₁, y₁, z₁ [symbol] , . . . , [symbol] x_{M}, y_{M}, z_{M} [symbol] }, the baseline model ƒ is initially trained by updating its parameters via stochastic gradient descent (SGD) as:

$${θ}_{f} ← {θ}_{f} - α {∇}_{{θ}_{f}} {ℒ}_{c} ( f )$$

Here α and [symbol] _{c}(ƒ) are the learning rate and the loss function for ƒ, respectively.

For the learning problems of supervised regression, [symbol] _{c}(ƒ) takes the form:

$${ℒ}_{c} ( f ) = {\sum }_{〈 {x}_{i} , {y}_{i} , {z}_{i} 〉 ∈ 𝒟} {‖ f ( {x}_{i} ) - {y}_{i} ‖}_{2}^{2}$$

For the learning problems of supervised classification, [symbol] _{c}(ƒ) takes the form:

$${ℒ}_{c} ( f ) = {\sum }_{〈 {x}_{i} , {y}_{i} , {z}_{i} 〉 ∈ 𝒟} ( {y}_{i} log f ( {x}_{i} ) + ( 1 - {y}_{i} ) log ( 1 - f ( {x}_{i} ) ) )$$

For the learning problems of reinforcement learning, [symbol] _{c}(ƒ) takes the form:

$${ℒ}_{c} ( f ) = {\sum }_{〈 {x}_{i} , {y}_{i} , {z}_{i} 〉 ∈ 𝒟} {‖ f ( {x}_{i} ) - ( {y}_{i} + γ {max}_{{a}^{′}} f ( {x}_{i}^{′} ) ) ‖}_{2}^{2}$$

Here, D⊆ [symbol] is a data episode in the trusted or golden dataset, xᵢ= [symbol] sᵢ, aᵢ [symbol] , sᵢ and aᵢ are the state and action in the i-th data point in

$$D . {x}_{i}^{′} = 〈 {s}_{i}^{′} , {a}^{′} 〉$$

and a′ is the action that can be taken under

$${s}_{i}^{′} .$$

γ∈[0, 1) is the discount factor.

For the judge model g, it is trained as:

$${θ}_{g} ← {θ}_{g} - β {∇}_{{θ}_{g}} {ℒ}_{s} ( g )$$

Here, [symbol] ₛ(g) takes the form:

$${ℒ}_{s} ( g ) = {\sum }_{〈 {x}_{i} , {y}_{i} , {z}_{i} 〉 ∈ 𝒟} {‖ g ( {x}_{i} , {y}_{i} ) - {z}_{i} ‖}_{2}^{2}$$

where β and [symbol] ₛ(g) are the learning rate and the loss function for g, respectively.

When a new dataset

$${𝒟}^{+} = \{ 〈 {x}_{1}^{+} , {y}_{1}^{+} 〉 , … , 〈 {x}_{N}^{+} , {y}_{N}^{+} 〉 \}$$

arrives, the dynamic model ƒ⁺ is trained as:

$${θ}_{{f}^{+}} ← {θ}_{{f}^{+}} - η {∇}_{{θ}_{{f}^{+}}} {ℒ}_{h} ( {f}^{+} )$$

Here, η and [symbol] ₕ(ƒ⁺) are the learning rate and the loss function for ƒ⁺, respectively.

For the learning problems of supervised regression, [symbol] ₕ(ƒ⁺) takes the form:

$${ℒ}_{h} ( {f}^{+} ) = {\sum }_{〈 {x}_{j}^{+} , {y}_{j}^{+} 〉 ∈ {D}^{+}} {‖ {f}^{+} ( {x}_{j}^{+} ) - {y}_{j}^{*} ‖}_{2}^{2}$$

Here,

$${y}_{j}^{*}$$

is the aligned standard label:

$${y}_{j}^{*} = \{ \begin{matrix}f ( {x}_{j}^{+} ) & {max}_{〈 x , y , z 〉 ∈ 𝒟} v ( {x}_{j}^{+} , x ) \geq τ and g ( {x}_{j}^{+} , f ( {x}_{j}^{+} ) ) \geq λ \\ y & {max}_{〈 x , y , z 〉 ∈ 𝒟} v ( {x}_{j}^{+} , x ) \geq τ but g ( {x}_{j}^{+} , f ( {x}_{j}^{+} ) ) < λ \\ {y}_{j}^{+} & otherwise\end{matrix}$$

### Here,

$$v ( {x}_{j}^{+} , x )$$

is a scalar value indicating the possibility that

$${x}_{j}^{+}$$

can be transformed to x in the same representation space, τ∈[0, 1] is the hyper-parameter of transformation threshold, and λ∈[0, 1] is the hyper-parameter to trade-off between the model's adaptivity to new data and reliability to the trusted or golden standard.

For the learning problems of supervised classification, [symbol] ₕ(ƒ⁺) takes the form:

$${ℒ}_{h} ( {f}^{+} ) = {\sum }_{〈 {x}_{j}^{+} , {y}_{j}^{+} 〉 ∈ {𝒟}^{+}} ( {y}_{j}^{*} log {f}^{+} ( {x}_{j}^{+} ) + ( 1 - {y}_{j}^{*} ) log ( 1 - {f}^{+} ( {x}_{j}^{+} ) ) )$$

For the learning problems of reinforcement learning, [symbol] ₕ(ƒ⁺) takes the form:

$${ℒ}_{h} ( {f}^{+} ) = {\sum }_{〈 {x}_{j}^{+} , {y}_{j}^{+} 〉 ∈ {D}^{+}} {‖ {f}^{+} ( {x}_{j}^{+} ) - ( {y}_{j}^{*} + γ {max}_{{( {a}^{+} )}^{′}} {f}^{+} ( {( {x}_{j}^{+} )}^{′} ) ) ‖}_{2}^{2}$$

Here D⁺⊆ [symbol] is a data episode in the new dataset,

$${x}_{j}^{+} = 〈 {s}_{j}^{+} , {a}_{j}^{+} 〉 , {s}_{j}^{+} and {a}_{j}^{+}$$

are the state and action in the j-th data point in

$${D}^{+} \cdot {( {x}_{j}^{+} )}^{′} = 〈 {( {s}_{j}^{+} )}^{′} , {( {a}^{+} )}^{′} 〉$$

and (a⁺)′ is the action that can be taken under

$${( {s}_{j}^{+} )}^{′} .$$

γ∈[0, 1) is the discount factor.

Once the dynamic model ƒ⁺ converges, the baseline model ƒ is updated with it. In the meantime, for each data point

$$〈 {x}_{j}^{+} , {y}_{j}^{+} 〉 ∈ {𝒟}^{+} , {y}_{j}^{+}$$

is updated with

$${y}_{j}^{*} .$$

The evaluation score value indicating the credibility of the mapping from

$${x}_{j}^{+} and {y}_{j}^{*}$$

is estimated as:

$${z}_{j}^{+} = g ( {x}_{j}^{+} , {y}_{j}^{*} )$$

In this way, the new dataset becomes

$${𝒟}^{+} = \{ 〈 {x}_{1}^{+} , {y}_{1}^{*} , {z}_{1}^{+} 〉 , ⋯ , 〈 {x}_{N}^{+} , {y}_{N}^{*} , {z}_{N}^{+} 〉 \}$$

Finally, the trusted or golden dataset is augmented by appending the new dataset to it as

$$𝒟 ← 𝒟 + {𝒟}^{+}$$

As embodied and broadly described herein, the baseline, judge, and dynamic models can be each implemented as a common-sense machine learning model. Their individual learning rates can be independently scheduled (configured and dynamically adjusted) throughout their training process to improve convergence.

More specifically, the learning rates for the models are hyperparameters in a range of zero to one, which control how fast the models converge. The learning rates can be manually or automatically fixed, adapted or tuned. In some cases, the learning rates are initially fixed and later made adaptive (either manually adjusted during training or automatically adjusted by optimizers or learning rate schedules). In one embodiment, the initial learning rates for the three models are different. In a non-limiting example, the initial learning rate for the baseline model could be 0.001, the initial learning rate for the judge model could be 0.01, and the initial learning rate for the dynamic model could be 0.002. Thereafter, the convergence of the models could be monitored and the learning rates could be adjusted accordingly. Models often use adaptive learning rates or decaying learning rates to optimize convergence and improve training efficiency.

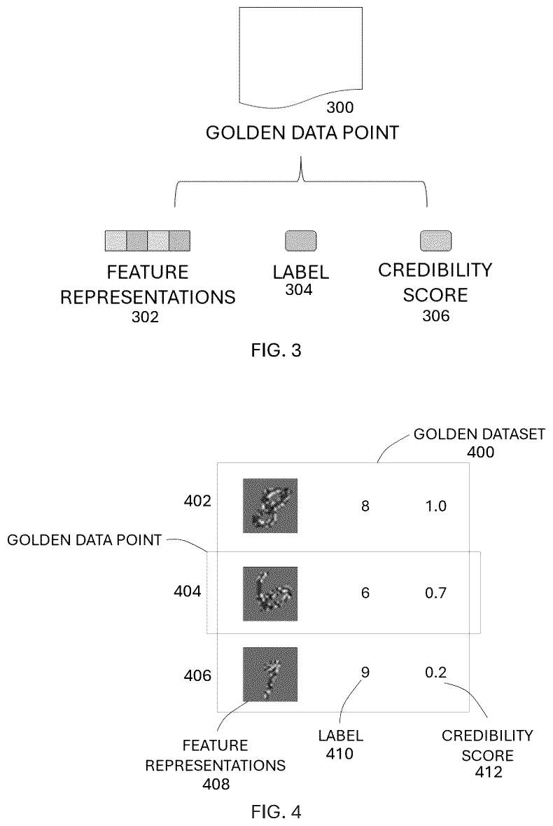

Referring now to FIG. 3, three components of a data point 300 in the trusted or golden dataset are shown. Each data point 300 in the trusted or golden dataset contains a set of feature representations 302, a label 304 and a credibility score 306. The feature representations 302 are a meaningful set of features that capture essential characteristics of the raw data, which allows the models to learn patterns and make predictions. The label 304 is a specific category or value assigned to the set of feature representations 302. The credibility score 306 is a numerical value assigned to the set of feature representations 302 and the label 304 indicating the reliability degree of the mapping between the feature representations 302 and the label 304.

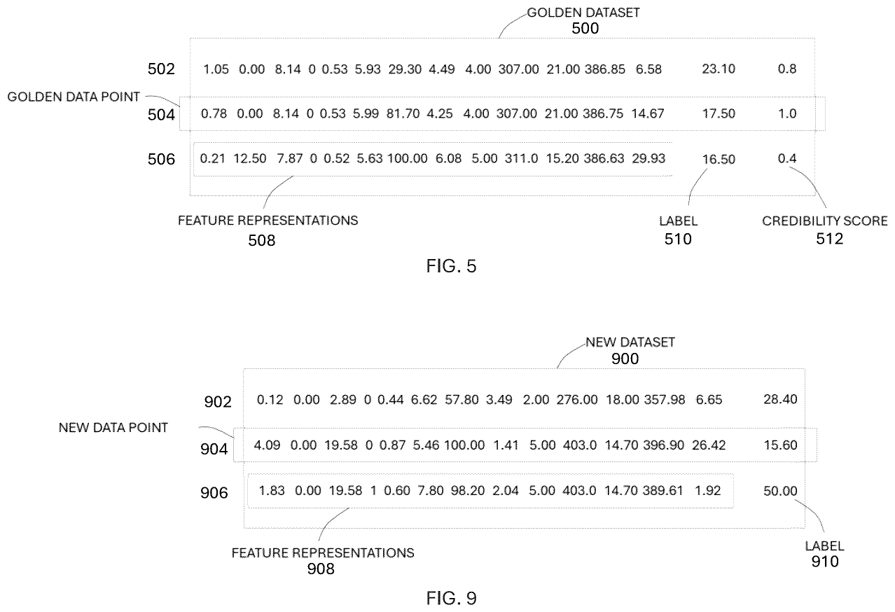

Now referring to FIGS. 4-6, exemplary data points in the trusted or golden dataset for three different learning problems of supervised classification (FIG. 4), supervised regression (FIG. 5), and reinforcement learning (FIG. 6), respectively, are shown. Each data point 402, 404, 406, 502, 504, 506, 602, 604 and 606 contains a set of feature representations 408, 508 and 608, a label 410, 510 and 614, and a credibility score 412, 512 and 616, as explained above in reference to FIG. 3. The supervised classification example of FIG. 4 shows a golden data set 400 containing three golden data points 402, 404 and 406, each containing an image feature representation 408, a numeric label 410 and a numeric credibility score 412. The supervised regression example of FIG. 5 shows a golden dataset 500 containing three golden data points 502, 504 and 506, each containing a set of numerical feature representation 508, a numeric label 510 and a numeric credibility score 512. The supervised regression example of FIG. 6 shows a golden dataset 600 containing three golden data points 602, 604 and 606, each containing feature representation 608 having a state 610 and an action 612, a numeric label 614 and a numeric credibility score 616. A data episode 618 may refer to multiple data points (e.g., 602, 604 and 606). Note that any type or configuration of feature representations, labels and credibility scores can be used. Moreover, the data points may include additional information.

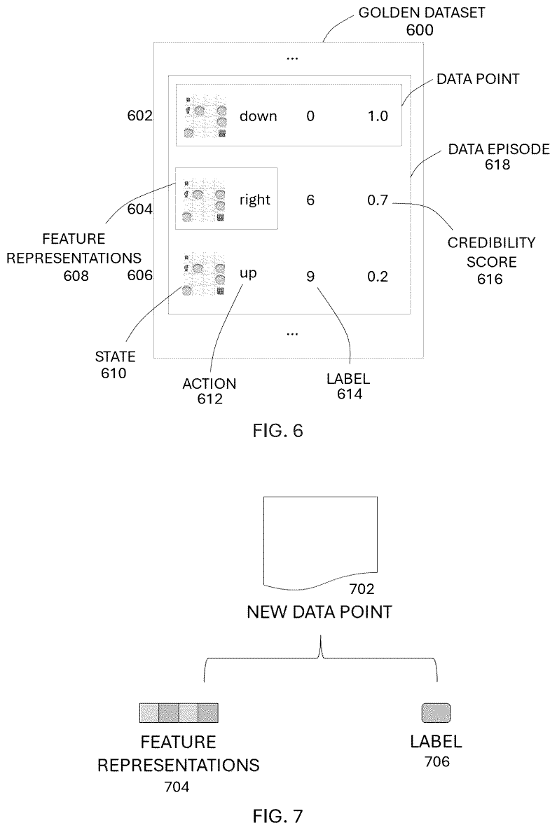

Referring now to FIG. 7, two components, a feature representation 704 and label 706, of a new data point 702 in the initial dataset and the newly arrived dataset are shown. Unlike a data point in the trusted or golden dataset, each data point 702 in the initial dataset and the newly arrived dataset contains only the feature representation 704 and the corresponding label 706. Note that data points in other embodiments may include additional information.

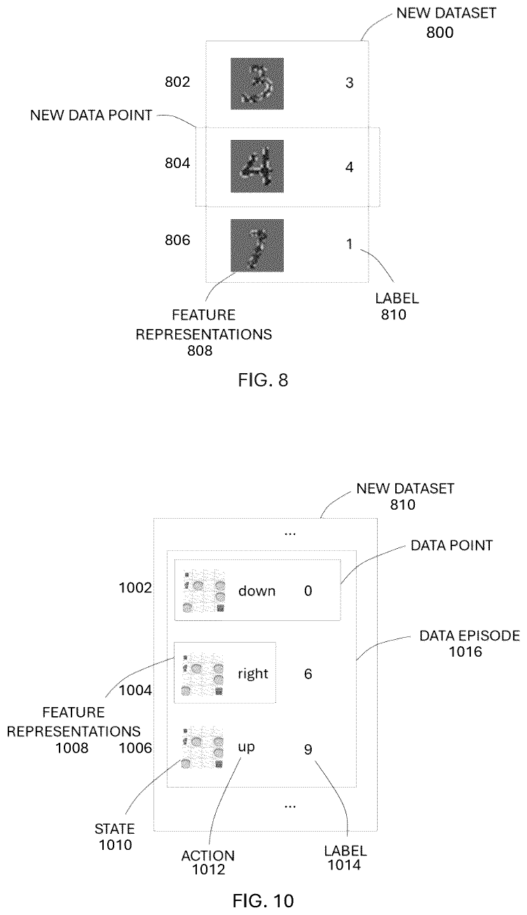

Now referring to FIGS. 8-10, exemplary data points in the initial dataset and the newly arrived dataset for three different learning problems of supervised classification (FIG. 8), supervised regression (FIG. 9), and reinforcement learning (FIG. 10), respectively, are shown.

Each data point 802, 804, 806, 902, 904, 906, 1002, 1004 and 1006 contains a set of feature representations 808, 908 and 1008 and a label 810, 910 and 1014 as explained above in reference to FIG. 7. The supervised classification example of FIG. 8 shows a new dataset 800 containing three data points 802, 804 and 806, each containing an image feature representation 808 and a numeric label 810. The supervised regression example of FIG. 9 shows a new dataset 900 containing three data points 902, 904 and 906, each containing a set of numerical feature representation 908 and a numeric label 910. The supervised regression example of FIG. 10 shows a new dataset 1000 containing three data points 1002, 1004 and 1006, each containing feature representation 1008 having a state 1010 and an action 1012, and a numeric label 1014.

A data episode 1016 may refer to multiple data points (e.g., 1002, 1004 and 1006). Note that any type or configuration of feature representations, labels and credibility scores can be used. Moreover, the data points may include additional information.

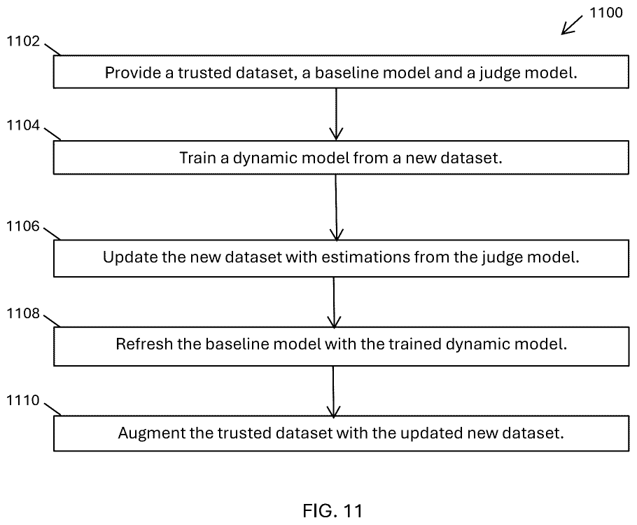

Referring now to FIG. 11, a flow diagram of a method 1100 for building artificial intelligence (AI) models or agents with immunity according to an implementation of the disclosure is shown. The method 1100 includes providing a trusted dataset, a baseline model and a judge model in block 1102, training a dynamic model from a new dataset in block 1104, updating the new dataset with estimations from the judge model in block 1106, refreshing the baseline model with the trained dynamic model in block 1108, and augmenting the trusted dataset with the updated new dataset 1110.

In one aspect, the training, updating, refreshing, augmenting and saving steps are repeated continuously, periodically, upon request, or upon receiving additional new datasets. In another aspect, the method further includes receiving one or more queries or tasks, and responding to the one or more queries or tasks using the augmented trusted dataset. In another aspect, providing the trusted dataset includes building the trusted dataset, by a processing device or a system or a computerized tool, from an initial dataset; providing the baseline model includes training the baseline model from the trusted dataset; and providing the judge model includes training the judge model from the trusted dataset. In another aspect, building the trusted dataset further includes determining whether a mapping from a feature representation to a label is credible or not, and determining a credibility score of the mapping for each data point in the initial dataset. In another aspect, determining the credibility score of the mapping for each data point in the initial dataset is conducted by humans, experts, or computerized systems based on authoritative evaluations. In another aspect, the credibility score of the mapping for each data point in the initial dataset is determined by an evaluation algorithm. In another aspect, training the baseline model from the trusted dataset further includes fetching feature representations and labels for all data points in the trusted dataset, and training the baseline model by updating one or more baseline model parameters via stochastic gradient descent (SGD). In another aspect, fetching the feature representations includes fetching digitalized representations or vectorized real-valued embeddings. In another aspect, training the judge model from the trusted dataset further includes fetching feature representations, labels and credibility scores for all data points in the trusted dataset, and training the judge model by updating one or more judge model parameters via stochastic gradient descent (SGD). In another aspect, fetching the feature representations include fetching digitalized representations or vectorized real-valued embeddings. In another aspect, training the dynamic model includes fetching feature representations and labels for all data points from the new dataset, specifying an aligned label for each data point in the new dataset, and updating one or more dynamic model parameters via stochastic gradient descent (SGD). In another aspect, fetching the feature representations includes fetching digitalized representations or vectorized real-valued embeddings. In another aspect, specifying the aligned label for each data point in the new dataset includes estimating a predicted value for the feature representation of each data point in the new dataset, estimating a maximum transformation probability of the feature representation of each data point in the new dataset to the feature representations over all existing data points in the trusted dataset, and locating the data point in the trusted dataset which holds the maximum transformation probability. In another aspect, estimating the predicted value for the feature representation of each data point in the new dataset is obtained from an output from the baseline model by taking the feature representation of the data point in the new dataset as an input. In another aspect, estimating the maximum transformation probability of the feature representation of each data point in the new dataset to the feature representations over all existing data points in the trusted dataset is based on a similarity between the feature representation of each data point in the new dataset and the feature representation over all existing data points in the trusted dataset. In another aspect, updating the new dataset with estimations from the judge model includes estimating a credibility score for each data point in the new dataset, augmenting each data point with the estimated credibility score. In another aspect, estimating the credibility score for each data point in the new dataset is obtained from an output from the judge model by taking the feature representation and the label of the data point in the new dataset as an input. In another aspect, refreshing the baseline model with the trained dynamic model refreshes one or more baseline model parameters with one or more dynamic model parameters. In another aspect, augmenting the trusted dataset with the updated new dataset appends the updated new dataset to the trusted dataset.

The foregoing method and system can be implemented as one or more non-transitory computer-readable media that stores instructions that when executed cause a computing device or system to perform the stated operations

It is contemplated that any aspects of the disclosure discussed in this specification can be implemented with respect to any method, apparatus or system of the disclosure, and vice versa.

It will be understood that particular aspects described herein are shown by way of illustration and not as limitations of the disclosure. The principal features of this disclosure can be employed in various aspects without departing from the scope of the disclosure. Those skilled in the art will recognize, or be able to ascertain using no more than routine experimentation, numerous equivalents to the specific procedures described herein. Such equivalents are considered to be within the scope of this disclosure and are covered by the claims.

All publications and patent applications mentioned in the specification are indicative of the level of skill of those skilled in the art to which this disclosure pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. In aspects of any of the compositions and methods provided herein, “comprising” may be replaced with “consisting essentially of” or “consisting of”. As used herein, the phrase “consisting essentially of” requires the specified integer(s) or steps as well as those that do not materially affect the character or function of the claimed invention. As used herein, the term “consisting” is used to indicate the presence of the recited integer (e.g., a feature, an element, a characteristic, a property, a method/process step or a limitation) or group of integers (e.g., feature(s), element(s), characteristic(s), propertie(s), method/process steps or limitation(s)) only.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB.

Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

As used herein, words of approximation such as, without limitation, “about”, “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skilled in the art recognize the modified feature as still having the required characteristics and capabilities of the unmodified feature. In general, but subject to the preceding discussion, a numerical value herein that is modified by a word of approximation such as “about” may vary from the stated value by at least ±1, 2, 3, 4, 5, 6, 7, 10, 12 or 15%.

Additionally, the section headings herein are provided for consistency with the suggestions under 37 CFR 1.77 or otherwise to provide organizational cues. These headings shall not limit or characterize the disclosure(s) set out in any claims that may issue from this disclosure. Specifically, and by way of example, although the headings refer to a “Field of Invention,” such claims should not be limited by the language under this heading to describe the so-called technical field. Further, a description of technology in the “Background of the Invention” section is not to be construed as an admission that technology is prior art to any disclosure(s) in this disclosure. Neither is the “Summary” to be considered a characterization of the disclosure(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure but should not be constrained by the headings set forth herein.

All of the compositions and/or methods disclosed and claimed herein can be made and executed without undue experimentation in light of the present disclosure. While the compositions and methods of this disclosure have been described in terms of preferred aspects, it will be apparent to those of skill in the art that variations may be applied to the compositions and/or methods and in the steps or in the sequence of steps of the method described herein without departing from the concept, spirit and scope of the disclosure. All such similar substitutes and modifications apparent to those skilled in the art are deemed to be within the spirit, scope and concept of the disclosure as defined by the appended claims.

To aid the Patent Office, and any readers of any patent issued on this application in interpreting the claims appended hereto, applicants wish to note that they do not intend any of the appended claims to invoke paragraph 6 of 35 U.S.C. § 112, U.S.C. § 112 paragraph (f), or equivalent, as it exists on the date of filing hereof unless the words “means for” or “step for” are explicitly used in the particular claim.

For each of the claims, each dependent claim can depend both from the independent claim and from each of the prior dependent claims for each and every claim so long as the prior claim provides a proper antecedent basis for a claim term or element.

What is claimed is:

1. A computer-implemented method for building an artificial intelligence model or agent, the method comprising:
providing a trusted dataset, a baseline model and a judge model;
training a dynamic model from a new dataset;
updating the new dataset with estimations from the judge model;
refreshing the baseline model with the trained dynamic model; and
augmenting the trusted dataset with the updated new dataset.

2. The method of claim 1, wherein the training, updating, refreshing, and augmenting steps are repeated continuously, periodically, upon request, or upon receiving additional new datasets.

3. The method of claim 1, further comprising;
receiving one or more queries or tasks; and
responding to the one or more queries or tasks using the augmented trusted dataset.

4. The method of claim 1, wherein:
providing the trusted dataset comprises building the trusted dataset, by a processing device or a system or a computerized tool, from an initial dataset;
providing the baseline model comprises training the baseline model from the trusted dataset; and
providing the judge model comprises training the judge model from the trusted dataset.

5. The method of claim 4, wherein building the trusted dataset further comprise:
determining whether a mapping from a feature representation to a label is credible or not; and
determining a credibility score of the mapping for each data point in the initial dataset indicating the credibility degree of the mapping from the feature representation to the corresponding label.

6. The method of claim 5, wherein determining the credibility score of the mapping for each data point in the initial dataset is conducted by humans, experts, or computerized systems based on authoritative evaluations.

7. The method of claim 6, wherein the credibility score of the mapping for each data point in the initial dataset is determined by an evaluation algorithm.

8. The method of claim 4, wherein training the baseline model from the trusted dataset further comprises:
fetching feature representations and labels for all data points in the trusted dataset; and
training the baseline model by updating one or more baseline model parameters via stochastic gradient descent (SGD).

9. The method of claim 8, wherein fetching the feature representations includes fetching digitalized representations or vectorized real-valued embeddings.

10. The method of claim 4, wherein training the judge model from the trusted dataset further comprises:
fetching feature representations, labels and credibility scores for all data points in the trusted dataset; and
training the judge model by updating one or more judge model parameters via stochastic gradient descent (SGD).

11. The method of claim 10, wherein fetching the feature representations include fetching digitalized representations or vectorized real-valued embeddings.

12. The method of claim 1, wherein training the dynamic model comprises:
fetching feature representations and labels for all data points from the new dataset;
specifying an aligned label for each data point in the new dataset; and
updating one or more dynamic model parameters via stochastic gradient descent (SGD).

13. The method of claim 12, wherein fetching the feature representations includes fetching digitalized representations or vectorized real-valued embeddings.

14. The method of claim 12, wherein specifying the aligned label for each data point in the new dataset comprises:
estimating a predicted value for the feature representation of each data point in the new dataset;
estimating a maximum transformation probability of the feature representation of each data point in the new dataset to the feature representations over all existing data points in the trusted dataset; and
locating the data point in the trusted dataset which holds the maximum transformation probability.

15. The method of claim 14, wherein estimating the predicted value for the feature representation of each data point in the new dataset is obtained from an output from the baseline model by taking the feature representation of the data point in the new dataset as an input.

16. The method of claim 14, wherein estimating the maximum transformation probability of the feature representation of each data point in the new dataset to the feature representations over all existing data points in the trusted dataset is based on a similarity between the feature representation of each data point in the new dataset and the feature representation over all existing data points in the trusted dataset.

17. The method of claim 1, wherein updating the new dataset with estimations from the judge model comprises:
estimating a credibility score for each data point in the new dataset; and
augmenting each data point with the estimated credibility score.

18. The method of claim 17, wherein estimating the credibility score for each data point in the new dataset is obtained from an output from the judge model by taking the feature representation and the label of the data point in the new dataset as an input.

19. The method of claim 1, wherein refreshing the baseline model with the trained dynamic model refreshes one or more baseline model parameters with one or more dynamic model parameters.

20. The method of claim 1, wherein augmenting the trusted dataset with the updated new dataset appends the updated new dataset to the trusted dataset.

21. A computerized system for building an artificial intelligence model or agent comprises:
a trusted dataset;
a baseline model;
a judge model
a dynamic model; and
one or more processors communicably coupled to the trusted dataset, the baseline model, the judge model and the dynamic model, wherein the one or more processors train the dynamic model from a new dataset, update the new dataset with estimations from the judge model, refresh the baseline model with the trained dynamic model, and augment the trusted dataset with the updated new dataset.

22. The computerized system of claim 21, wherein the one or more processors repeat the training, updating, refreshing, and augmenting steps continuously, periodically, upon request, or upon receiving additional new datasets.

23. The computerized system of claim 21, wherein the one or more processors further;
receive one or more queries or tasks; and
respond to the one or more queries or tasks using the augmented trusted dataset.

24. The computerized system of claim 21, wherein the one or more processors further:
build the trusted dataset from an initial dataset;
train the baseline model from the trusted dataset; and
train the judge model from the trusted dataset.

25. The computerized system of claim 24, wherein the one or more processors build the trusted dataset by:
determining whether a mapping from a feature representation to a label is credible or not; and
determining a credibility score of the mapping for each data point in the initial dataset indicating the credibility degree of the mapping from the feature representation to the corresponding label.

26. The computerized system of claim 25, wherein the one or more processors determine the credibility score of the mapping for each data point in the initial dataset from input received from humans, experts, or computerized systems based on authoritative evaluations.

27. The computerized system of claim 26, wherein the credibility score of the mapping for each data point in the initial dataset is determined by an evaluation algorithm.

28. The computerized system of claim 24, wherein the one or more processors train the baseline model from the trusted dataset by:
fetching feature representations and labels for all data points in the trusted dataset; and
training the baseline model by updating one or more baseline model parameters via stochastic gradient descent (SGD).

29. The computerized system of claim 28, wherein fetching the feature representations includes fetching digitalized representations or vectorized real-valued embeddings.

30. The computerized system of claim 24, wherein the one or more processors train the judge model from the trusted dataset by:
fetching feature representations, labels and credibility scores for all data points in the trusted dataset; and
training the judge model by updating one or more judge model parameters via stochastic gradient descent (SGD).

31. The computerized system of claim 30, wherein fetching the feature representations include fetching digitalized representations or vectorized real-valued embeddings.

32. The computerized system of claim 21, wherein the one or more processors train the dynamic model by:
fetching feature representations and labels for all data points from the new dataset;
specifying an aligned label for each data point in the new dataset; and
updating one or more dynamic model parameters via stochastic gradient descent (SGD).

33. The computerized system of claim 32, wherein fetching the feature representations includes fetching digitalized representations or vectorized real-valued embeddings.

34. The computerized system of claim 32, wherein specifying the aligned label for each data point in the new dataset comprises:
estimating a predicted value for the feature representation of each data point in the new dataset;
estimating a maximum transformation probability of the feature representation of each data point in the new dataset to the feature representations over all existing data points in the trusted dataset; and
locating the data point in the trusted dataset which holds the maximum transformation probability.

35. The computerized system of claim 34, wherein estimating the predicted value for the feature representation of each data point in the new dataset is obtained from an output from the baseline model by taking the feature representation of the data point in the new dataset as an input.

36. The computerized system of claim 34, wherein estimating the maximum transformation probability of the feature representation of each data point in the new dataset to the feature representations over all existing data points in the trusted dataset is based on a similarity between the feature representation of each data point in the new dataset and the feature representation over all existing data points in the trusted dataset.

37. The computerized system of claim 21, wherein the one or more processors update the new dataset with estimations from the judge model by:
estimating a credibility score for each data point in the new dataset; and
augmenting each data point with the estimated credibility score.

38. The computerized system of claim 37, wherein estimating the credibility score for each data point in the new dataset is obtained from an output from the judge model by taking the feature representation and the label of the data point in the new dataset as an input.

39. The computerized system of claim 21, wherein the one or more processors refresh the baseline model with the trained dynamic model by refreshing one or more baseline model parameters with one or more dynamic model parameters.

40. The computerized system of claim 21, wherein the one or more processors augment the trusted dataset with the updated new dataset by appending the updated new dataset to the trusted dataset.
